(19) United States
(12) Patent Application Publication
(10) Pub. No.: US 2020/0241838 A1
(43) Pub. Date: Jul. 30, 2020

(54) HOME APPLIANCE SYSTEM

(71) Applicant: Toshiba Lifestyle Products & Services Corporation, Kawasaki-shi (JP)

(72) Inventors: Yuuki MARUTANI, Nagakute-shi (JP); Yukio MACHIDA, Owariasahi-shi (JP); Hlroaki KAWAGUCHI, Kasugai-shi (JP); Yoshihiko UJITA, Owariasahi-shi (JP); Tsubasa WASHIZAKI, Toyota-shi (JP); Kengo MATSUNAGA, Nagoya-shi (JP)

(73) Assignee: Toshiba Lifestyle Products & Services Corporation, Kawasaki-shi (JP)

(21) Appl. No.: 16/651,092

(22) PCT Filed: Aug. 27, 2018
(86) PCT No.: PCT/JP2018/031589

§ 371 Date: Mar. 26, 2020

(30) Foreign Application Priority Data
Oct. 3, 2017 (JP) 2017-193539

(51) Int. Cl. G06F 3/16; G10L 15/08; G06F 9/54; H04L 12/28; H04L 29/08

(52) U.S. Cl. CPC G06F 3/167; G10L 15/08; G06F 9/542; H04L 2012/285; H04L 67/125; G10L 2015/088; H04L 12/2816

(57) ABSTRACT

The home appliance system comprises a detector capable of communicating with a plurality of home appliances and configured to detect speech of a user and a controller. The controller is configured to specify one or more home appliances from among the plurality of home appliances based on a content of the speech of the user detected by the detector.

### TECHNICAL FIELD

The art disclosed herein relates to a home appliance system.

### BACKGROUND ART

Patent Document 1 describes an air conditioner provided with a speech recognition means and an operation control means. In this air conditioner, when speech recognized by the speech recognition means is a control instruction, the operation control means controls operation of the air conditioner based on a speech recognition result thereof.

### CITATION LIST

[Patent Document 1] JP 5020222 B1

### SUMMARY OF INVENTION

### Technical Problem

A general household has a plurality of home appliances aside from an air conditioner. For example, it may have home appliances such as a refrigerator, a laundry machine, a robotic vacuum cleaner, and an air conditioner. Further, when such a plurality of home appliances is present, there may be a case where operations of the plurality of home appliances should be controlled. With speech recognition of Patent Document 1, when there is a plurality of home appliances, it cannot recognize an operation of which one of the home appliances is to be controlled. Thus, the description herein provides an art for a case where a plurality of home appliances is present, that enables to specify one or more home appliances even if a user does not say a name of a particular home appliance.

### Solution to Technical Problem

The home appliance system disclosed herein comprises a detector capable of communicating with a plurality of home appliances and configured to detect speech of a user and a controller. The controller is configured to specify one or more home appliances from among the plurality of home appliances based on a content of the speech of the user detected by the detector.

### BRIEF DESCRIPTION OF DRAWINGS

FIG. 1 is a diagram schematically showing a configuration of a home appliance system of a first embodiment.

FIG. 2 is a diagram schematically showing a configuration of a detector of the first embodiment.

FIG. 3 is a block diagram showing the configuration of the detector of the first embodiment.

FIG. 4 is a table showing an example of a corresponding relationship between keywords included in a content of speech of the user and home appliances.

FIG. 5 is a sequence diagram showing processes executed in the home appliance system of the first embodiment.

FIG. 6 is a diagram schematically showing a configuration of a home appliance system of a second embodiment.

FIG. 7 is a sequence diagram showing processes executed in a home appliance system of a third embodiment.

FIG. 8 is a sequence diagram showing processes executed in a home appliance system of a fourth embodiment.

FIG. 9 is a sequence diagram showing processes executed in a home appliance system of a fifth embodiment.

### DESCRIPTION OF EMBODIMENTS

### First Embodiment

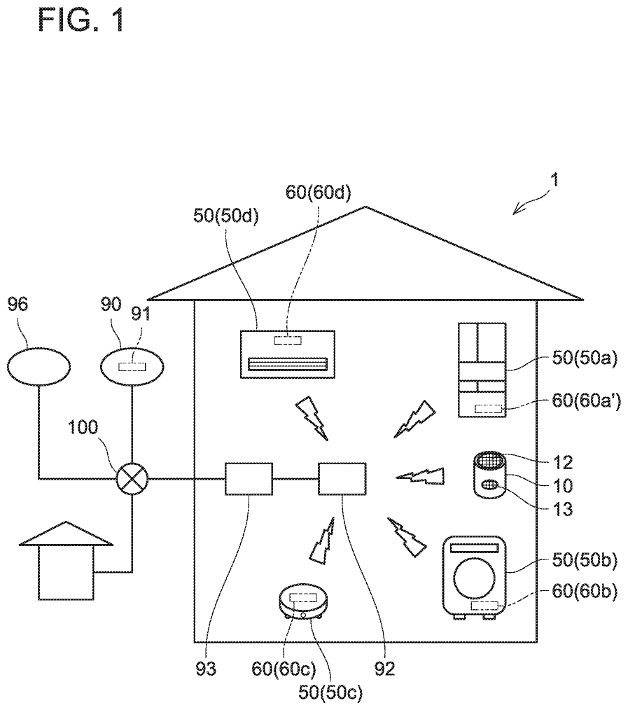

A home appliance system 1 of an embodiment will be described in detail with reference to the drawings. As shown in FIG. 1, the home appliance system 1 of the first embodiment is provided with a detector 10 and a plurality of home appliances 50.

The detector 10 is disposed in a living room of a house, for example. A position where the detector 10 is to be disposed is not particularly limited, and the detector 10 may for example be disposed in one of a kitchen, a dining room, a bedroom, and a nursery room of the house. The detector 10 is capable of wirelessly communicating with the plurality of home appliances 50 disposed in the house. A communication scheme of the detector 10 and the home appliances 50 is not particularly limited. Further, the detector 10 is connected to an external first server 90 through a wireless router 92, a modem 93, and the Internet 100, and is capable of communicating with the external first server 90. The detector 10 may be capable of communicating with the plurality of home appliances 50 through the first server 90. The first server 90 is connected to an external second server 96 through the Internet 100. The first server 90 is provided with a controller 91.

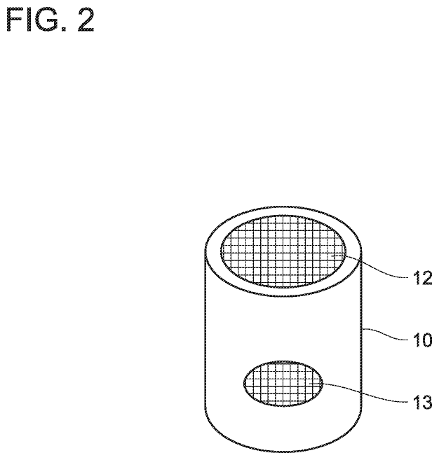

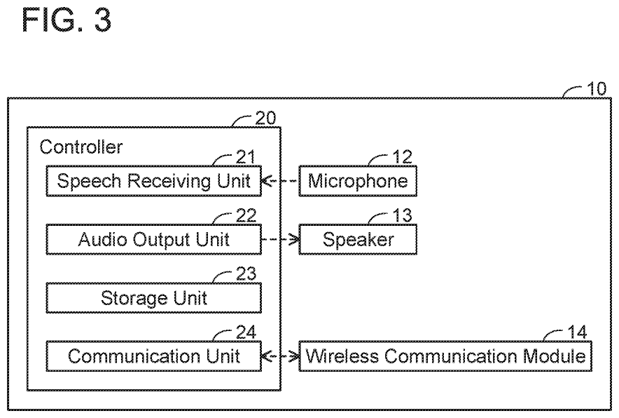

As shown in FIG. 2, the detector 10 is provided with a microphone 12 and a speaker 13. Further, as shown in FIG. 3, the detector 10 is provided with a wireless communication module 14 and a controller 20. The detector 10 is a device configured to detect speech of a user of the home appliance system 1.

The microphone 12 of the detector 10 is a device configured to acquire speech in a surrounding of the detector 10. When the user of the home appliance system 1 speaks in the surrounding of the detector 10, speech thereof is acquired by the microphone 12. The microphone 12 may for example be configured to acquire speech in a range of 5 meters radius from the detector 10. The speech acquired by the microphone 12 is sent to the controller 20 of the detector 10.

The speaker 13 of the detector 10 is a device configured to output audio to the surrounding of the detector 10. The speaker 13 is configured to notify information to the user of the home appliance system 1 by audio. For example, the speaker 13 notifies information related to the home appliances 50 in audio to the user who is present in the surrounding of the detector 10. The user who is present in the surrounding of the detector 10 can acknowledge the information notified by the audio outputted from the speaker 13.

The wireless communication module 14 of the detector 10 is provided for wireless communication with the plurality of home appliances 50 and the wireless router 92. Transmission and reception of information are executed through the wireless communication module 14.

The controller 20 of the detector 10 is provided with a speech receiving unit 21, an audio output unit 22, a storage unit 23, and a communication unit 24. The speech receiving unit 21 of the controller 20 is configured to receive a signal of the speech acquired by the microphone 12 from the microphone 12. Further, the audio output unit 22 is configured to output a signal of audio to be outputted to the surrounding of the detector 10 to the speaker 13. Further, the communication unit 24 is configured to execute transmission and reception of information through the wireless communication module 14. Further, the storage unit 23 stores analytic speech data for analyzing the speech which the speech receiving unit 21 received from the microphone 12. Details of control executed by the controller 20 of the detector 10 will be described later.

As shown in FIG. 1, the plurality of home appliances 50 in the home appliance system 1 is connected to the external first server 90 through the wireless router 92, the modem 93, and the Internet 100, and is capable of communicating with the external first server 90. Each of the home appliances 50 is provided with a communication unit that is not shown. The plurality of home appliances 50 in the home appliance system 1 may for example be a refrigerator 50a, a laundry machine 50b, a robotic vacuum cleaner 50c, and an air conditioner 50d. Each of the home appliances 50 (50a, 50b, 50c, 50d) is provided with a controller 60 (60a, 60b, 60c, 60d). Types of the home appliances 50 are not particularly limited, and may for example be a microwave, a rice cooker, a TV, a Blu-ray disk player, and a DVD player.

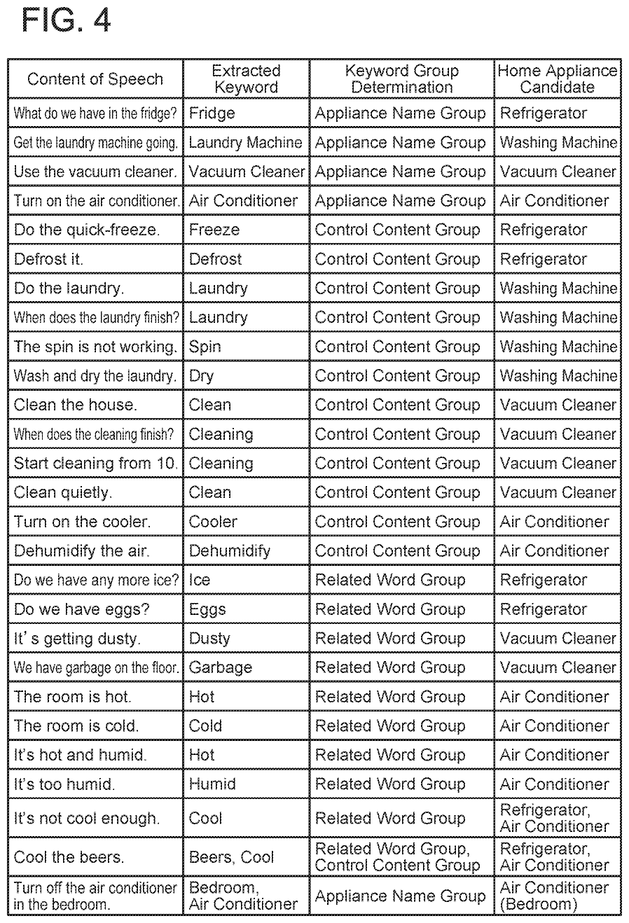

Next, the speech of the user of the home appliance system 1 will be described. In the house, the user of the home appliance system 1 says various things. In such occasions, a content of the speech of the user may be related to one or more home appliances 50 in the home appliance system 1. That is, as shown in FIG. 4, keyword(s) included in the speech of the user may be related to one or more home appliances 50. For example, the user may say: “what do we have in the fridge?”, “wash and dry the laundry.”, “clean the house.”, “this room is hot.”, “cool the beers.”, and the like. When the user says “what do we have in the fridge?” or “cool the beers.”, the content of such speech is related to the refrigerator 50a. Further, when the user says “wash and dry the laundry.”, the content of such speech is related to the laundry machine 50b. The keyword(s) included in the respective contents of speech of the user are related to the respective home appliances 50. In the above home appliance system 1, various processes are executed based on the content of the speech of the user as above. This feature will be described below. The corresponding relationship of the contents of speech, the keywords, and the home appliances 50 shown in FIG. 4 is a mere example and does not cast any particular limitation.

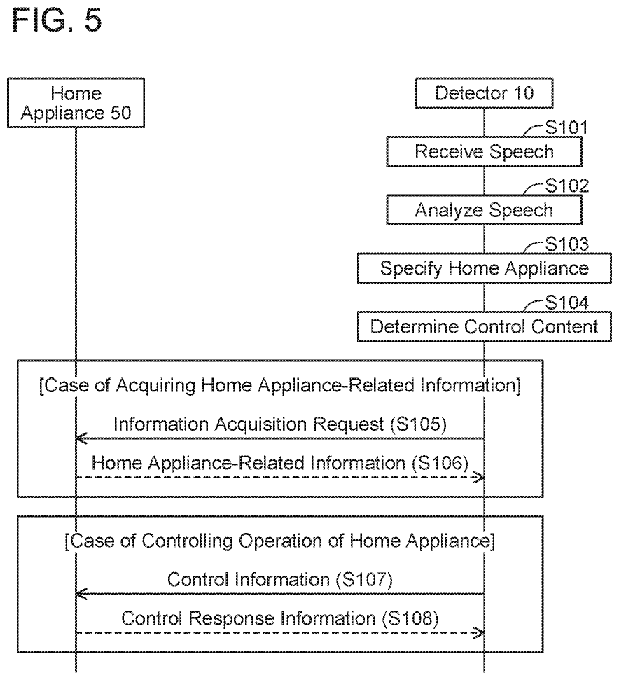

Next, the processes executed in the home appliance system 1 will be described. As shown in FIG. 5, when a power of the detector 10 is turned on, the home appliance system 1 firstly executes a process of step S101. In step S101, the speech receiving unit 21 of the detector 10 receives the speech spoken by the user of the home appliance system 1. In the home appliance system 1, when the user says something, the microphone 12 of the detector 10 acquires the speech thereof and sends the same to the controller 20. For example, when the user of the home appliance system 1 says “what do we have in the fridge?” and “cool the beers.”, the microphone 12 of the detector 10 acquires the speech thereof and sends the same to the controller 20. Then, the speech receiving unit 21 of the controller 20 receives the speech thereof (“what do we have in the fridge?” and “cool the beers.”).

Next in step S102, the controller 20 executes analysis on the speech received by the speech receiving unit 21 by using the analytic speech data stored in the storage unit 23. The controller 20 analyzes the speech and extracts the keyword(s) included therein. For example, the controller 20 analyzes the speech “what do we have in the fridge?” received by the speech receiving unit 21 and extracts the keyword “fridge” included in the speech as shown in FIG. 4. Further, the controller 20 analyzes the speech “cool the beers.” received by the speech receiving unit 21 and extracts the keywords “beers” and “cool” included in the speech. The keyword “fridge” is a keyword in an appliance name group. Further, the keyword “beer” is a keyword in a related word group, and the keyword “cool” is a keyword in a control content group.

As shown in FIG. 5, next in step S103, the controller 20 specifies a home appliance 50 related to the keyword(s) based on the keyword(s) extracted by the speech analysis. For example, the controller 20 specifies the home appliance 50 related to the extracted keyword “fridge”, that is, the “refrigerator 50a”, from among the plurality of home appliances 50 in the home appliance system 1. Further, based on the extracted keywords “beers” and “cool”, the controller 20 may specify the “refrigerator 50a” related to these keywords.

Next in step S104, the controller 20 determines a control content for the home appliance 50 specified in the above step S103 (such as the refrigerator 50a). The controller 20 determines the control content related to the keyword(s) based on the keyword(s) extracted by the speech analysis. For example, based on the extracted keyword “cool”, the controller 20 determines the control content of reducing a temperature inside a compartment of the refrigerator 50a to cool the compartment.

Then, in a case of acquiring home appliance-related information, the controller 20 executes a process of step S105. The home appliance-related information is information related to the home appliance 50 specified by the controller 20 in the above step S103 (such as the refrigerator 50a). The home appliance-related information includes information on articles within the compartment of the refrigerator 50a and information of the temperature in the compartment, for example.

In step S105, the controller 20 of the detector 10 sends an information acquisition request to the home appliance 50 (such as the refrigerator 50a). The controller 60 of the home appliance 50 receives this information acquisition request. Then, in step S106, the controller 60 of the home appliance 50 sends the home appliance-related information to the detector 10 in response to the received information acquisition request. This home appliance-related information is received by the controller 20 of the detector 10.

Next, in a case of controlling an operation of the home appliance 50 specified in the above step S103 (such as the refrigerator 50a), the controller 20 of the detector 10 executes a process of step S107. The controller 20 controls the operation of the home appliance 50 (such as the refrigerator 50a) based on the control content determined in the above step S104.

In step S107, the controller 20 of the detector 10 sends control information to the home appliance 50 (such as the refrigerator 50a). The control information is received by the controller 60 of the home appliance 50. The control information is information related to the control content of the home appliance 50 (such as the refrigerator 50a). The control information includes information for reducing the temperature inside the compartment of the refrigerator 50a to cool the compartment, for example. Next, in step S108, the controller 60 of the home appliance 50 sends control response information to the detector 10 in response to the received control information. This control response information is received by the controller 20 of the detector 10. Further, the controller 60 of the home appliance 50 controls the operation based on the received control information. For example, the controller 60 executes control to reduce the temperature inside the compartment of the refrigerator 50a to cool the compartment.

As above, the home appliance system 1 of the first embodiment has been described. As it is apparent from the foregoing explanation, the home appliance system 1 is provided with the detector 10 capable of communicating with the plurality of home appliances 50 and configured to detect the speech of the user, and the controller 20 in the detector 10. The controller 20 is configured to specify one home appliance 50 (such as the refrigerator 50a) from among the plurality of home appliances 50 based on the content of the speech of the user detected by the detector 10. More specifically, the controller 20 is configured to specify, based on the one or more keywords (such as “fridge”, “beers”, “cool”) included in the speech of the user, one home appliance 50 (such as the refrigerator 50a) related to such keywords.

According to this configuration, for example, in the case where the user says “cool the beers.”, the home appliance 50 (refrigerator 50a) can be specified from the content of this speech even if the user does not say the name of the particular home appliance 50 (such as the refrigerator 50a). Also in a case where the user says the name of the particular home appliance 50 (such as the refrigerator 50a), the home appliance 50 (refrigerator 50a) can be specified. Further, since the controller 20 of the detector 10 specifies the home appliance 50, the controller 20 can execute information processing in a local environment, by which a processing speed can be increased. In the foregoing explanation, the case in which the controller 20 of the detector 10 specifies the refrigerator 50a has been described, however, same processes as above are executed for cases of specifying other home appliances 50 (laundry machine 50b, robotic vacuum cleaner 50c, air conditioner 50d, etc.).

Further, in the above home appliance system 1, the controller 20 is configured to acquire the information related to the specified home appliance 50 (such as the refrigerator 50a) from this home appliance 50 (such as the refrigerator 50a). Due to this, the borne appliance-related information acquired in regard to the home appliance 50 (such as the refrigerator 50a) can be effectively utilized.

Further, in the above home appliance system 1, the controller 20 is configured to control the operation of the specified home appliance 50 (such as the refrigerator 50a) based on the content of the speech of the user. Due to this, the operation of the home appliance 50 can suitably be controlled. For example, in the case where the user says “cool the beers.”, the controller 20 executes the control to reduce the temperature inside the compartment of the refrigerator 50a to cool the compartment based on the content of this speech. Thus, the home appliance system 1 can meet demands of the user.

One specific embodiment has been described above, however, specific configuration is not limited to the foregoing embodiment. In the description below, configurations that are same as the configurations in the foregoing description will be given same reference signs and descriptions thereof will be omitted.

### Second Embodiment

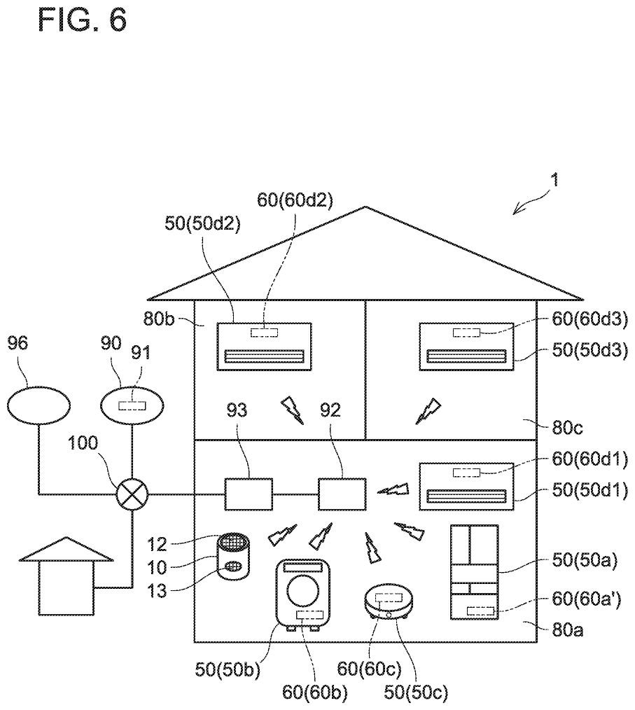

In the above home appliance system 1, there is a case where a plurality of home appliances 50 is specified based on the content of the speech of the user. For example, there is a case in which home appliances 50 of a same type are present within the house in which the home appliance system 1 is installed. More specifically, as shown in FIG. 6, there is a case in which a plurality of rooms is present within the house (such as a living room 80a on a first floor and a bedroom 80b and a nursery room 80c on a second floor) and home appliances 50 of the same type (such as air conditioners 50d) are disposed in the respective rooms. For example, a first air conditioner 50d1 is disposed in the living room 80a on the first floor, a second air conditioner 50d2 is disposed in the bedroom 80b on the second floor, and a third air conditioner 50d3 is disposed in the nursery room 80c on the second floor.

It is hereby assumed that the user of the home appliance system I says “turn off the air conditioner in the bedroom.” in such a situation, for example. In this case, the controller 20 of the detector 10 specifies the plurality of air conditioners 50d based on a keyword “air conditioner” included in this speech of the user. Further, the controller 20 specifies the second air conditioner 50d2 disposed in the bedroom 80b based on a keyword “bedroom” included in the speech of the user. Further, it is hereby assumed that the user says “turn off the air conditioner upstairs.”, for example. In this case, the controller 20 of the detector 10 specifies the second air conditioner 50d2 disposed in the bedroom 80b on the second floor and the third air conditioner 50d3 disposed in the nursery room 80c on the second floor based on keywords “upstairs” and “air conditioner” included in the speech of the user.

As above, in the home appliance system 1 of the second embodiment, in the case where a plurality of home appliances 50 (such as the air conditioners 50d) is specified based on the content of the speech of the user, the controller 20 of the detector 10 further specifies, based on the keywords included in the speech of the user, one or more home appliances 50 (such as the second air conditioner 50d2 in the bedroom 80b or the second air conditioner 50d2 and the third air conditioner 50d3 on the second floor) related to the keywords from among the specified plurality of home appliances 50 (such as the air conditioners 50d).

The keywords “bedroom” and “upstairs” included in the speech of the user in the above example are examples of classification information for specifying one or more home appliances 50 (such as the second air conditioner 50d2 in the bedroom 80b or the second air conditioner 50d2 and the third air conditioner 50d3 on the second floor) from among the plurality of home appliances 50 of the same type. According to this configuration, even in the case where the plurality of home appliances 50 of the same type is present, the one or more home appliances 50 can be specified thereamong based on the classification information. The controller 20 may specify the one or more home appliances 50 based on a combination of a plurality of classification information.

### Third Embodiment

In the above home appliance system 1, home appliances 50 related to a keyword may overlap. In this case, a process of a third embodiment is executed. For example, it is hereby assumed that the user of the home appliance system 1 says “it's not cool enough.”. Then, in the above step S101, the speech receiving unit 21 of the detector 10 receives the speech which the user had spoken (“it's not cool enough.”). Further, in step S102, the controller 20 of the detector 10 analyzes the speech “it's not cool enough.” which the speech receiving unit 21 received, and extracts the keyword “cool” included in the speech. Further, in step S103, the controller 20 specifies the home appliances 50 related to the keyword “cool” extracted by speech analysis. As shown in FIG. 4, there are the “refrigerator 50a” and the “air conditioner 50d” as the home appliances 50 related to the keyword “cool” extracted by the controller 20. That is, there is a plurality of candidates of the home appliances 50 (which in this case are the refrigerator 50a and the air conditioner 50d) specified based on the keyword “cool”. In such a case, a process of following step S111 is executed.

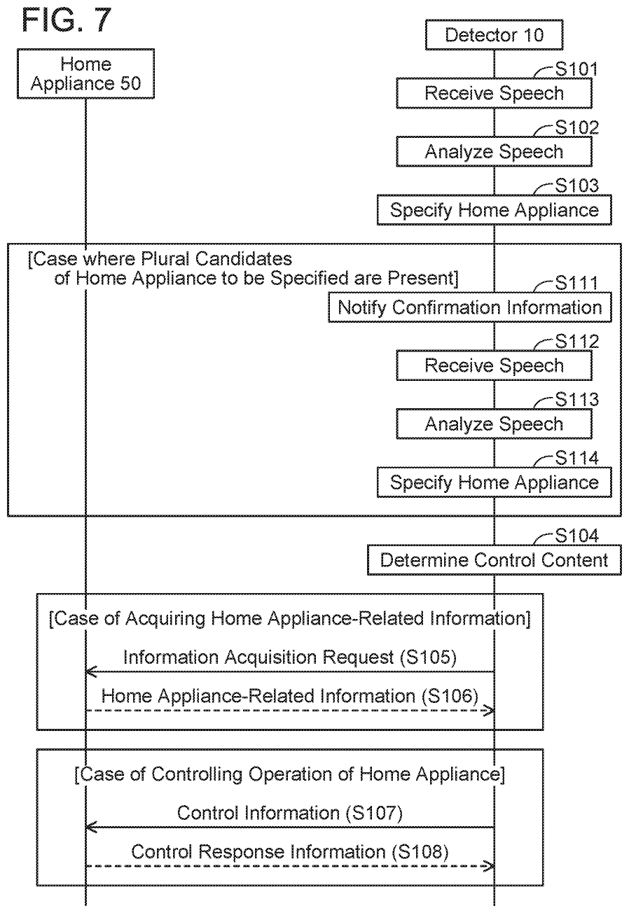

As shown in FIG. 7, in step S111, the controller 20 notifies confirmation information to the user by the speaker 13 of the detector 10. The confirmation information is information indicating that there are plural candidates of the home appliance 50 specified based on the keyword(s) extracted by the controller 20. The controller 20 outputs audio such as “what's not cool enough?”, “is the grocery not cool enough?”, or “is the room not cool enough?” from the speaker 13 to the user present in the surrounding of the detector 10. The audio as above are examples of the confirmation information.

It is hereby assumed that the user of the home appliance system 1 says “the beers are not cool enough.” in response to the confirmation information notified from the speaker 13. Then, in step S112 which follows step S111, the microphone 12 of the detector 10 acquires this speech and sends the same to the controller 20. The speech receiving unit 21 of the detector 10 receives this speech (“the beers are not cool enough.”).

Next in step S113, the controller 20 analyzes the speech received by the speech receiving unit 21. The controller 20 analyzes the speech and extracts the keyword included in the speech. For example, the controller 20 analyzes the speech “the beers are not cool enough.” received by the speech receiving unit 21 and extracts the keyword “beers” included in the speech.

Next in step S114, the controller 20 specifies, based on the keyword “beers” extracted by the speech analysis, the home appliance 50 related to the keyword, that is, the “refrigerator 50a”. In a case where the user of the home appliance system 1 says “the bedroom is not cool enough.” in response to the confirmation information, for example, the controller 20 specifies the second air conditioner 50d2 disposed in the bedroom 80b based on the keyword “bedroom” included in the above speech. After this, the processes from step S104 to step S108 are executed. The processes from step S104 to step S108 have been described in the first embodiment, thus detailed description thereof will be hereby omitted.

As above, in the home appliance system 1 of the third embodiment, in the case where plural candidates of the home appliance 50 specified based on the content of the speech of the user are present, the controller 20 is configured to notify the confirmation information indicating such a situation to the user by using the speaker 13 (an example of a notification unit). According to this configuration, for example, in the case where the user says “it's not cool enough.”, the candidates of the home appliance 50 (the refrigerator and the air conditioner) can be specified from the content of this speech (“it's not cool enough.”) even if the user does not say the name of the particular home appliance 50 (such as the refrigerator or the air conditioner). Further, since the confirmation information is notified by the speaker 13, the user can select a specific home appliance 50 from among the plurality of candidates. Further, the home appliance 50 can be specified based on the content of the speech of the user in response to the confirmation information.

### Fourth Embodiment

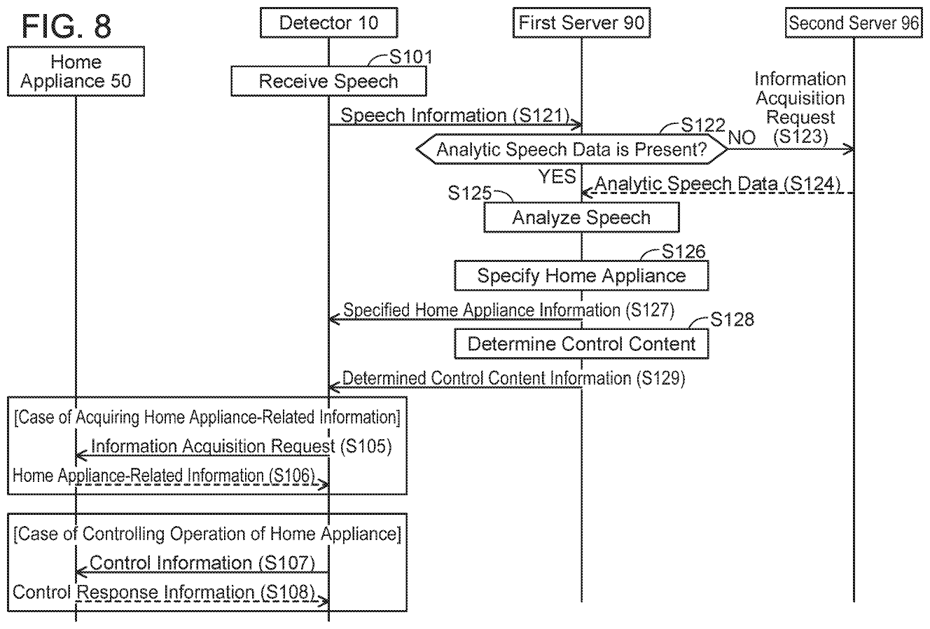

In the above embodiments, the controller 20 of the detector 10 specifies the home appliance(s) 50 (such as the refrigerator 50a) based on the content of the speech of the user, however, no limitation is cast upon this configuration, and the controller 91 of the first server 90 may specify the home appliance(s) 50 (such as the refrigerator 50a) based on the content of the speech of the user. In the home appliance system 1 of a fourth embodiment, as shown in FIG. 8, a process of steps S121 is executed following the process of the above step S101. In step S121, the controller 20 of the detector 10 sends the information on the speech which the speech receiving unit 21 received in step S101 (such as “what do we have in the fridge?”, “cool the beers.”) to the first server 90. This speech information is received by the controller 91 of the first server 90.

Next in step S122, the controller 91 of the first server 90 determines whether or not analytic speech data for analyzing the speech received in step S121 is present in the first server 90. In a case where the analytic speech data is present in the first server 90, the controller 91 determines YES to step S122 and proceeds to step S125. On the other hand, in a case where the analytic speech data is not present in the first server 90, the controller 91 determines NO to step S122 and executes a process of step S123.

In step S123, the controller 91 of the first server 90 sends information acquisition request to the external second server 96. This information acquisition request is received by a controller (not shown) of the second server 96. Then in step S124, the controller of the second server 96 sends the analytic speech data to the first server 90 in response to the received information acquisition request. The analytic speech data is present in the second server 96. This analytic speech data is received by the controller 91 of the first server 90.

Next in step S125, the controller 91 analyzes the speech received in the above step S121 by using the analytic speech data received in the above step S124. The controller 91 analyzes the speech and extracts keyword(s) included in the speech. For example, the controller 91 analyzes the speech “what do we have in the fridge?” and extracts the keyword “fridge” included in the speech. Further, the controller 91 analyzes the speech “cool the beers.” and extracts the keywords “cool” and “beers” included in the speech.

Next in step S126, the controller 91 of the first server 90 specifies the home appliance 50 related to the keyword(s) based on the keyword(s) extracted by the speech analysis. For example, the controller 91 specifies, from among the plurality of home appliances 50 in the home appliance system 1, the home appliance 50 related to the extracted keyword “fridge”, that is, the “refrigerator 50a”. Further, based on the extracted keywords “beers” and “cool”, the controller 91 may specify the “refrigerator 50a” related to these keywords. Next in step S127, the controller 91 sends the home appliance information of the home appliance 50 (refrigerator 50a) specified in step S126 to the detector 10. This home appliance information is received by the controller 20 of the detector 10.

Next in step S128, the controller 91 of the first server 90 determines the control content for the home appliance 50 specified in the above step S126 (such as the refrigerator 50a). The controller 91 determines the control content related to the keyword(s) based on the keyword(s) extracted by the speech analysis. For example, based on the extracted keyword “cool”, the controller 91 determines the control content of reducing the temperature inside the compartment of the refrigerator 50a to cool the compartment. Next in step S129, the controller 91 sends information on the control content determined in step S128 to the detector 10. The control content information is received by the controller 20 of the detector 10.

After this, the processes from step S105 to step S108 are executed based on the home appliance information and the control content information which the controller 20 of the detector 10 received in the above step S127 and step S129. Since the processes from step S105 to step S108 have been described in the first embodiment, detailed description thereof will be omitted.

As above, in the home appliance system 1 of the fourth embodiment, the controller 91 of the first server 90 is configured to specify the home appliance 50 (such as the refrigerator 50a) based on the content of the speech of the user. According to this configuration, since data is stored in the first server 90 in a larger volume than in the detector 10, the home appliance 50 can be specified based on such large-volume data. According to this configuration, accuracy of the speech analysis becomes higher.

### Fifth Embodiment

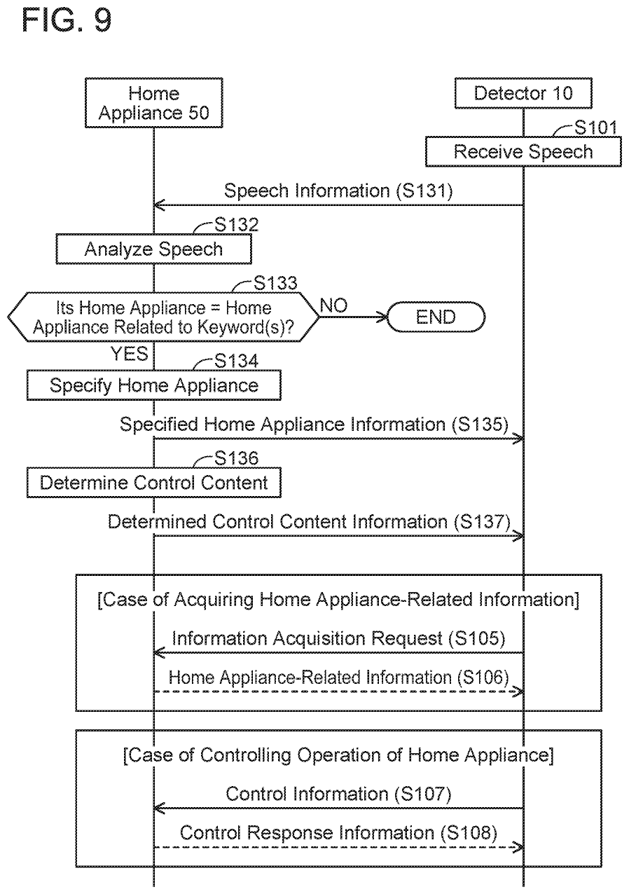

In the above embodiments, the controller 20 of the detector 10 or the controller 91 of the first server 90 specified the home appliance 50 (such as the refrigerator 50a) based on the content of the speech of the user, however, no limitation is cast upon such configurations, and the controller 60 of each of the home appliances 50 may specify its corresponding home appliance 50 (such as the refrigerator 50a, the air conditioner 50d) based on the content of the speech of the user. In the home appliance system 1 of the fifth embodiment, as shown in FIG. 9, a process of step S131 is executed following the process of the above step S101. In step S131, the controller 20 of the detector 10 sends the information of the speech which the speech receiving unit 21 received in step S101 (such as “what do we have in the fridge?” and “cool the beers.”) to the home appliances 50. The home appliances 50 to which the speech information is to be sent may for example be the refrigerator 50a. This speech information is received by the controller 60 of each of the home appliances 50 (such as the refrigerator 50a).

Next in step S132, the controller 60 of each home appliance 50 analyzes the speech received in step S131. A storage unit (not shown) of the home appliances 50 stores the analytic speech data for analyzing the speech. The controller 60 analyzes the speech using the analytic speech data stored in the storage unit, and extracts keyword(s) included in the speech. For example, the controller 60 analyzes the speech “what do we have in the fridge?” and extracts the keyword “fridge” included in this speech. Further, the controller 60 analyzes the speech “cool the beers.” and extracts the keywords “beers” and “cool” included in this speech.

Next in step S133, based on the keyword(s) extracted in the speech analysis, the controller 60 of the home appliance 50 determines whether or not the home appliance 50 of itself is the home appliance 50 related to the keyword(s). For example, in the case where the keyword which the controller 60 extracted is “fridge”, the home appliance 50 related to this keyword is the refrigerator 50a. In a case where the home appliance 50 of itself is the refrigerator 50a, it matches the home appliance 50 (refrigerator 50a) related to the keywords, thus the controller 60 determines YES to step S133. The controller 60 proceeds to step S134 in a case of YES to step S133. On the other hand, in a case where the home appliance 50 of itself is not the home appliance 50 (such as the refrigerator) related to the keyword (such as a case where the home appliance 50 of itself is the air conditioner 50d), the controller 60 determines NO to step S133 and terminates the process.

Next in step S134, the controller 60 of the home appliance 50 specifies that the home appliance 50 (refrigerator) related to the extracted keyword is the home appliance 50 (refrigerator 50a) of itself. Next in step S135, the controller 60 sends the home appliance information of the home appliance 50 (refrigerator 50a) specified in step S134 to the detector 10. This home appliance information is received by the controller 20 of the detector 10.

Next in step S136, the controller 60 of the home appliance 50 determines the control content for the home appliance 50 (such as the refrigerator 50a) specified in the above step S134. Based on the keyword(s) extracted by the speech analysis, the controller 60 determines the control content related to the keyword(s). For example, the controller 60 determines the control content of reducing the temperature inside the compartment of the refrigerator 50a to cool the compartment based on the extracted keyword “cool”. Next in step S137, the controller 60 sends the information on the control content determined in step S136 to the detector 10. This control content information is received by the controller 20 of the detector 10.

After this, the processes from step S105 to step S108 are executed based on the home appliance information and the control content information which the controller 20 of the detector 10 received in the above step S135 and step S137. Since the processes from step S105 to step S108 have been described in the first embodiment, detailed description thereof will be omitted.

Further, the case in which the home appliance 50 is the refrigerator 50a is described above, however, similar processes are executed in other home appliances 50 (such as the laundry machine 50b, the robotic vacuum cleaner 50c, the air conditioner 50d, etc.). As above, in the home appliance system 1 of the fifth embodiment, the controller 60 of each of the home appliances 50 (such as the refrigerator 50a, the laundry machine 50b, the robotic vacuum cleaner 50c, the air conditioner 50d, etc.) is configured to specify its corresponding home appliance 50 based on the content of the speech of the user. According to this configuration, since the controller 60 of each of the home appliances 50 executes the specifying process, the respective home appliances 50 can be specified independently.

Respective embodiments have been described above, however, the specific configuration is not limited to the foregoing embodiments. For example, in another embodiment, when the controller of the home appliance system 1 is to specify one or more home appliances 50 based on the content of the speech of the user, the home appliances 50 may be specified by machine learning such as deep learning.

Specific examples of the present invention have been described in detail, however, these are mere exemplary indications and do not intend to limit the scope of the claims. These examples may be carried out in various other configurations, and may be subjected to various types of omissions, substitutions, and modifications within the scope that does not deviate from the essence of the invention. Such examples and modifications thereof are encompassed by the scope of the invention and the essence, at the same time as which may be encompassed by the inventions recited in the claims and the equivalents thereof.

### REFERENCE SIGNS LIST

1: home appliance system
10: detector
12: microphone
13: speaker
14: wireless communication module
20: controller
21: speech receiving unit
22: audio output unit
23: storage unit
24: communication unit
50: home appliances
50a: refrigerator
50b: laundry machine
50c: robotic vacuum cleaner
50d: air conditioner
60: controller
80a: living room
80b: bedroom
80c: nursery room
90: first server
91: controller
92: wireless router
93: modem
96: second server
100: Internet

1. A home appliance system comprising:
a detector capable of communicating with a plurality of home appliances and configured to detect speech of a user: and
a controller,
wherein
the controller specifies one or more home appliances from among the plurality of home appliances based on a content of the speech of the user detected by the detector.

2. The home appliance system according to claim 1, wherein the controller is configured to specify, based on one or more keywords included in the speech of the user, the one or more home appliances related to the one or more keywords.

3. The home appliance system according to claim 1 or 2, wherein the controller is configured to acquire information related to the specified one or more home appliances from the specified one or more home appliances.

4. The home appliance system according to any one of claims 1 to 3, wherein the controller is configured to control operations of the specified one or more home appliances based on the content of the speech of the user.

5. The home appliance system according to any one of claims 1 to 4, wherein in a case where the specified one or more home appliances specified based on the content of the speech of the user are a plurality of home appliances, the controller is configured to specify, based on one or more pieces of classification information included in the speech of the user, one or more home appliances related to the one or more pieces of classification information from among the plurality of home appliances.

6. The home appliance system according to any one of claims 1 to 5, wherein
the detector comprises a notification unit, and
in a case where a plurality of candidates of the home appliances specified based on the content of the speech of the use is present, the controller notifies the user, of confirmation information by using the notification unit, the confirmation information indicating that the plurality of candidates is present.

7. The home appliance system according to any one of claims 1 to 6, wherein
the detector comprises the controller, and
the controller of the detector specifies the one or more home appliances based on the content of the speech of the user.

8. The home appliance system according to any one of claims 1 to 6, further comprising a server that is capable of communicating with the detector and comprises the controller,
wherein the controller of the server specifies the one or more home appliances based on the content of the speech of the user.

9. The home appliance system according to any one of claims 1 to 6, wherein
the plurality of home appliances capable of communicating with the detector each comprises the controller, and
each of the controllers of the plurality of home appliances specifies corresponding one of the home appliances based on the content of the speech of the user.
